(19) United States
(12) Patent Application Publication
(10) Pub. No.: US 2018/0234806 A1
(43) Pub. Date: Aug. 16, 2018

(54) AUTONOMOUS, SOLAR-POWERED, VESSEL TRACKING AND SAFETY BEACON DEVICES AND METHODS THEREOF

(71) Applicants: Orolia SAS, Guidel (FR); McMurdo, Inc., Lanham, MD (US)

(72) Inventors: Jonas N. Olsen, Palo Alto, CA (US); Stephane Jincheleau, Guidel (FR)

(21) Appl. No.: 15/433,541

(22) Filed: Feb. 15, 2017

(51) Int. Cl. H04W 4/04; H04W 4/22; G08G 3/00; G08B 29/04

(52) U.S. Cl. CPC H04W 4/046; G08B 29/046; G08G 3/00; H04W 4/22

(57) ABSTRACT

An autonomous, solar-powered, vessel tracking and safety beacon device includes a global positioning system coupled to at least a solar power system, one or more communication systems coupled to the solar power system, and a vessel tracking and safety beacon microcontroller system. The microcontroller system is coupled to the global positioning system, the one or more communication systems, and the solar power system. The microcontroller system comprises a memory coupled to a processor which is configured to be capable of executing programmed instructions comprising and stored in the memory to provide vessel location information from the global positioning system, detect when an emergency alert has been activated, determine based on the vessel location information from the global positioning system, and transmit the emergency alert, and other messages, such as text messages, email, weather updates, revisions to geo-zones, or notifications of nearby mariners in distress, using the determined one of the one or more communication systems.

### FIELD

This technology generally relates to tracking and beacon devices and, more particularly, to autonomous, solar-powered, vessel tracking and safety beacon devices and methods thereof.

### BACKGROUND

Fishing is the most dangerous job in the world with more than 24,000 deaths per year. Currently, Vessel Monitoring System (VMS) equipped vessels can assist search and rescue teams to locate targets in boating emergency situations. The VMS equipped vessels are typically larger, commercial fishing fleets. Little attention has been paid—from a safety technology standpoint—to the much larger fleet, in terms of people employed and number of vessels, of small-scale fishing boats.

In addition to this, fishing requires monitoring of fishing vessels to prevent over fishing and protect species. In particular, vessel monitoring systems enable national fisheries administration to monitor vessel movement for compliance and enforcement purposes which is both a preventative and required regulatory action. Unfortunately, it is not easy to track all fishing vessels again because of a lack of an effective tracking system.

Further, governments are under increasing pressure to improve security and better manage economic zones by utilizing vehicle monitoring systems to identify and validate foreign vessels which approach or enter coastal waters. Again, it unfortunately is not easy to track all boating vessels because of a lack of an effective tracking system.

### SUMMARY

An autonomous, solar-powered, vessel tracking and safety beacon device includes a global positioning system coupled to at least a solar power system, one or more communication systems coupled to the solar power system, and a vessel tracking and safety beacon microcontroller system. The microcontroller system is coupled to the global positioning system, the one or more communication systems, and the solar power system. The microcontroller system comprises a memory coupled to a processor which is configured to be capable of executing programmed instructions comprising and stored in the memory to provide vessel location information from the global positioning system, detect when an emergency alert has been activated, determine based on the vessel location information from the global positioning system, and transmit the emergency alert using the determined one of the one or more communication systems. The microcontroller system may also facilitate the sending and receiving of text messages and other data from/to the vessel and from/to shore.

A method for making an autonomous, solar-powered, vessel tracking and safety beacon device includes providing a global positioning system coupled to at least a solar power system. At one or more communication systems are coupled to the solar power system, and a vessel tracking and safety beacon microcontroller system. The microcontroller system is coupled to the global positioning system, the one or more communication systems, and the solar power system. The microcontroller system comprises a memory coupled to a processor which is configured to be capable of executing programmed instructions comprising and stored in the memory to provide vessel location information from the global positioning system, detect when an emergency alert has been activated, determine based on the vessel location information from the global positioning system, and transmit the emergency alert using the determined one of the one or more communication systems.

This technology provides a number of advantages including providing effective and low cost autonomous, solar-powered, vessel tracking and safety beacon devices and methods thereof. In particular, this technology advantageously provides better monitoring and tracking to ensure a safer boating environment, better rescue coordination, and better enforcement and compliance with respect to fishing regulations and policies. This technology is solar powered, with a backup, rechargeable battery, to ensure continuous operation and can provide location tracking coverage for all maritime and polar regions. Additionally, this technology is tamper proof to ensure accuracy of vessel tracking for compliance and enforcement purposes and is capable of notifying authorities of unauthorized access. This technology also can be easily mounted, is rugged for all maritime conditions, and provides a clear indication of its current state. Further, this technology can reliably transmit a distress indication to a central department location, e.g. emergency responders, for processing and response and can receive return messages alerting that help is on the way as well as other necessary information between vessels and between a vessel and shore.

### BRIEF DESCRIPTION OF THE DRAWINGS

FIG. 1 is a maritime environment including an example of an autonomous, solar-powered, vessel tracking and safety beacon device;

FIG. 2 is an example of a block diagram of the autonomous, solar-powered, vessel tracking and safety beacon devices as shown in FIG. 1; and

FIG. 3 is a flow chart for an example of a method of using the autonomous, solar-powered, vessel tracking and safety beacon device.

### DETAILED DESCRIPTION

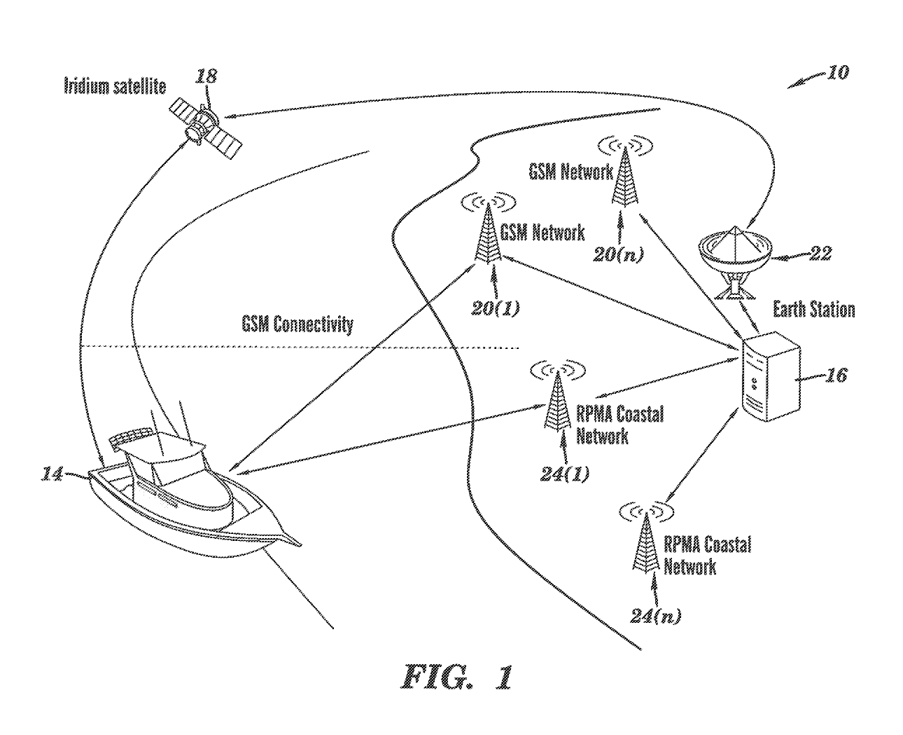

An exemplary environment 10 including an example of an autonomous, solar-powered, vessel tracking and safety vessel tracking and safety beacon device 14 is illustrated in FIG. 1. In this particular illustrative example, the vessel tracking and safety beacon device 14 may include, by way of example, a microcontroller 20, memory storage 22, an Iridium 9602 modem 24 and Iridium patch antenna 26, a 3G module 28 and 3G antenna 30, a thirty-two channel GPS module 32 and a GPS antenna 34, a Bluetooth radio module 36 and a Bluetooth antenna 38, a case open detection system 40, an audio alarm 42, an SOS button 44, an on/off switch 46, one or more LEDs 48, a solar panel 50 with a power conditioning system 52 and a rechargeable battery 54, although the tracking and safety vessel tracking and safety beacon device 14 may include other types and/or numbers of devices, components, and/or elements in other configurations. This technology provides a number of advantages including providing effective and low cost autonomous, solar-powered, vessel tracking and safety beacon devices and methods thereof.

Referring more specifically to FIG. 1, in this example in the environment 10 the vessel tracking and safety beacon device 14 depending on its current location may interact for tracking, safety, and/or communications with an Iridium satellite device 18 which is communicatively coupled with at least one earth station 22, one or more GSM network towers 20(1)-20(n), and/or one or more RPMA coastal network towers 24(1)-24(n) which all may be coupled to a tracking and safety monitoring server 16, although vessel tracking and safety beacon device 14 can include other types and/or numbers of devices, satellites, towers, communication systems, components, and/or elements in a variety of other topologies and deployments.

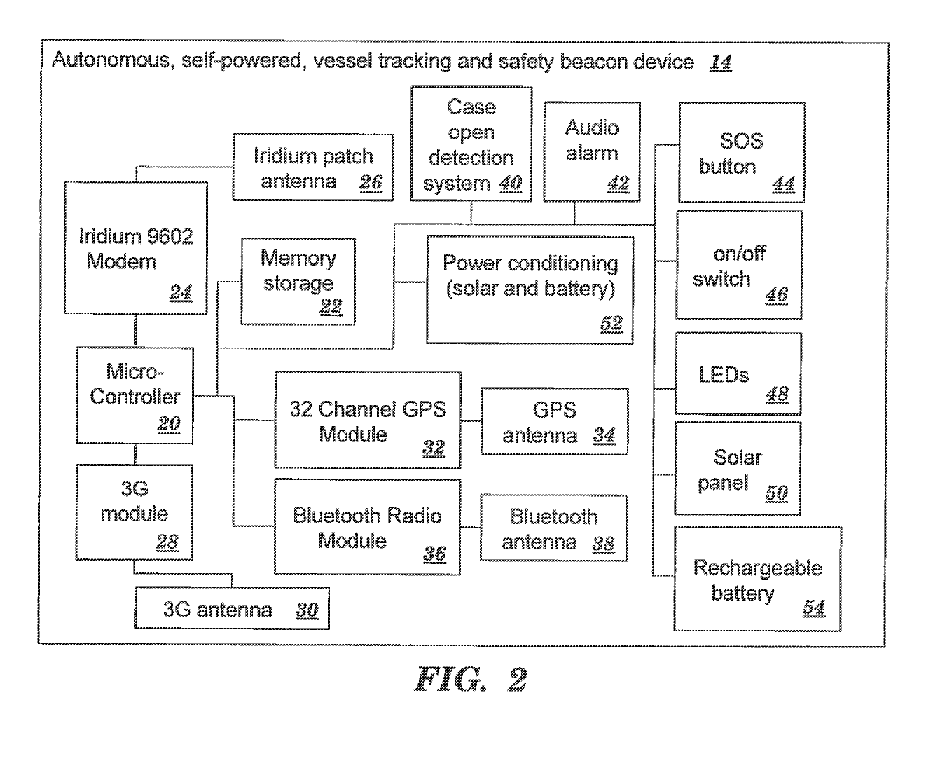

Referring more specifically to FIG. 2, in this example as noted above the vessel tracking and safety beacon device 14 may include, by way of example, a microcontroller 20, memory storage 22, an Iridium 9602 modem 24 and Iridium patch antenna 26, a 3G module 28 and 3G antenna 30, a thirty-two channel GPS module 32 and a GPS antenna 34, a Bluetooth radio module 36 and a Bluetooth antenna 38, a case open detection system 40, an audio alarm 42, an SOS button 44, an on/off switch 46, one or more LEDs 48, a solar panel 50 with a power conditioning system 52 and a rechargeable battery 54, although the tracking and safety vessel tracking and safety beacon device 14 may include other types and/or numbers of devices, components, and/or elements in other configurations.

The microcontroller 20 provides advanced features, such as active location monitoring, alarms in the event of entering illegal zones (pre-programmed geo-zones), power conservation and emergency alerts by way of example only. The microcontroller 22 may include a central processing unit (CPU) or processor, a memory, a display device, an input device, and a network interface device which are coupled together by a bus or other link, although other the vessel tracking and safety beacon device 14 may include other types and/or numbers of components and elements in other configurations and/or locations.

The processor in the microcontroller 20 executes a program of stored instructions for one or more aspects of the present technology as described and illustrated by way of the examples herein, although other types and/or numbers of processing devices and logic could be used and the processor could execute other types and/or numbers of programmed instructions. The processor in the microcontroller 20 may also be configured to periodically or on another schedule obtain updates and other upgrades through one of the communication systems which may be stored in the memory of the microcontroller 20 or in other locations, such as memory storage 22.

The memory in microcontroller 20 stores these programmed instructions for one or more aspects of the present technology as described and illustrated herein. A variety of different types of memory storage devices, such as a random access memory (RAM) and/or read only memory (ROM) in the timing processor device, or other computer readable medium which is read from and written to by a magnetic, optical, or other reading and writing system that is coupled to the processor in microcontroller 20, can be used for the memory. Additionally, by way of example only the microcontroller 20 may also be coupled to a separate memory storage device 22. Further the display device may comprise any type of display device to provide communications and other information and the input device may comprise any type of input device to enter in information.

In one example, the network interface device of the microcontroller 20 operatively couples and facilitates communication between the microcontroller 20 and the Iridium 9602 modem 24 and the Iridium patch antenna 26, the 3G module 28 and the 3G antenna 30, the thirty-two channel GPS module 32 and the GPS antenna 34, the Bluetooth radio module 36 and the Bluetooth antenna 38, the case open detection system 40, the audio alarm 42, the SOS button 44, the on/off switch 46, the one or more LEDs 48, and the solar panel 50 with the power conditioning system 52 and the rechargeable battery 54, although other types and/or numbers of communication networks or systems with other types and/or numbers of connections and configurations can be used.

The GPS antenna 34 is configured to receive GPS satellite signals and the thirty-two channel GPS module 32 coupled to the GPS antenna 34 is configured to determine and as needed provide the current location information, although the location information could be obtained in other manners. By way of example, the location information can be used for providing a current location when an emergency alert is transmitted or for monitoring and enforcement purposes for fishing regulations.

The Iridium 9602 SBD modem is coupled to the Iridium patch antenna 26 and provides completely global satellite coverage with access to Iridium short burst data messaging service, although other types of global communication systems could be used. In this particular example, the Iridium 9602 SBD modem with the Iridium patch antenna 26 can transmit two-way data packets from anywhere to anywhere. In this particular example, the microcontroller 20 may be configured to use the Iridium 9602 SBD modem and the Iridium patch antenna 26 for emergency and/or other communications when the vessel is outside the range of a GSM network. In this example, the Iridium 9602 SBD modem and the Iridium patch antenna 26 communicatively coupled to the Iridium satellite 18 which is communicatively coupled to the earth station 22 that is coupled to the tracking and safety monitoring server 16, although the Iridium 9602 SBD modem and the Iridium patch antenna 26 could be coupled to other locations.

A Random Phase Multiple Access (RPMA®) communication system in the vessel tracking and safety beacon device 14 is used for emergency and/or other communications when the vessel is between a distance range from shore, such as a distance between about 40-50 km off-shore, although other types of communication systems could be used. The RPMA communication system is communicatively coupled to one or more of the RPMA coastal network towers 24(1)-24(n) which are communicatively coupled to the tracking and safety monitoring server 16, although the RPMA communication system could be coupled to other locations.

The 3G module 28 is coupled to the 3G antenna 30 and is used for emergency and/or other communications when the vessel is within a set distance from shore, such as within 10 km off-shore, although other types of mobile communication systems could be used. The 3G module 28 and the 3G antenna 30 are communicatively coupled to one or more of the GSM network towers 20(1)-20(n) which are communicatively coupled to the tracking and safety monitoring server 16, although the 3G module 28 and the 3G antenna 30 could be coupled to other locations. Further, one or more of these communication systems can be combined by the microcontroller 20, such as Iridium/GSM for additional coverage and/or least cost routing by way of example.

The Bluetooth radio module 36 is coupled to the Bluetooth antenna 38 and may be used for embedded Bluetooth RF connectivity to smartphones or tablets for use onboard the vessel (shown in FIG. 1 by way of example) to receive and/or send messages and/or other data, such as maps, distress alert updates, weather forecasts, and/or updates on restricted areas by way of example, to and/or from the microcontroller 20 of the vessel tracking and safety beacon device 14. The Bluetooth radio module 36 and the Bluetooth antenna 38 may also provide smartphone connectivity with the GSM network towers 20(1)-20(n). This type of connectivity integrated with a vessel tracking and safety beacon device has not been provided before and provides far greater communication abilities and safety for mariners.

The case open detection system 40 is configured with one or more detection mechanisms to detect any attempt to open or otherwise tamper with the case which houses the vessel tracking and safety beacon device 14. Additionally, the case open detection system 40 is coupled to the microcontroller 20 to provide a tamper detect signal when any attempt to open or otherwise tamper with the case is detected and then the microcontroller 20 uses one of the communication systems to send off an alarm to the authorities using the appropriate one of the communication systems based on the current location of the vessel.

The audio alarm 42 and LEDs 48 are coupled to the microcontroller 20 and may be configured to provide audio and visual notifications and/or alarms in response to signals from the microcontroller 20. For example, one of the LEDs 48 may be turned on by the microcontroller 20 when the on/off switch 46 is turned on to provide a visual indication of the state of the vessel tracking and safety beacon device 14 and/or the audio alarm 42 might provide an audio indication of engagement, although other types and/or numbers of audio and/or visual notifications can be configured to be provided.

The SOS button 44 is coupled to the microcontroller 20 and when activated is used to signal the microcontroller 20 to generate and transmit a distress alert which may include other information, such as a vessel location as well as information input via the Bluetooth radio module 36 and Bluetooth antenna 38.

The optional on/off switch 46 enables the vessel tracking and safety beacon device 14 to be activated for use, although for enforcement and compliance may be within the case to prevent tampering. In this particular example, the on/off switch 46 is not exposed to the user may be configured to be turned to the on position once installed to begin autonomous operation and if removed provides another indication if tampering has occurred, although other configurations and access to the on/off switch can be used. By way of a further example, the on/off switch 46 may automatically turn on the vessel tracking and safety beacon device 14 when a magnet is detected on the mount used to attach the vessel tracking and safety beacon device 14 to the vessel. In particular, in this example when the vessel tracking and safety beacon device 14 “clicks” or is otherwise engaged into the mount, the magnet is detected and the on/off switch 46 turns the vessel tracking and safety beacon device 14 on. In this example, if the process is reversed and the magnet is no longer detected then the on/off switch 46 turns the vessel tracking and safety beacon device 14 off.

The solar panel 50 is coupled to a power conditioning system 52 and a rechargeable battery 54 which are used to obtain and provide power for the vessel tracking and safety beacon device 14, although other types and/or numbers of power sources can be used. With the solar panel 50, the power conditioning system 52 and the rechargeable battery 54 provides ample power to run the operation of the vessel tracking and safety beacon device 14 is provided. Mariners will never be out of power, even when staying out overnight. The vessel tracking and safety beacon device 14 may have an extra battery or other power source for power in rare situations where the solar panel does not contribute enough power, or during overnight trips.

In this example, the tracking and safety monitoring server 16 is located at an emergency tracking station or a maritime enforcement and compliance station by way of example only. The tracking and safety monitoring server 16 can include a central processing unit (CPU) or processor, a memory, a network interface device, an input and/or display device interface, and an antenna, which are coupled together by a bus or other link, although other types and/or numbers of network devices could be used. The tracking and safety monitoring server 16 may be configured to communicate and interact with the vessel tracking and safety beacon device 14, for example to provide emergency response information or fishing enforcement or compliance information.

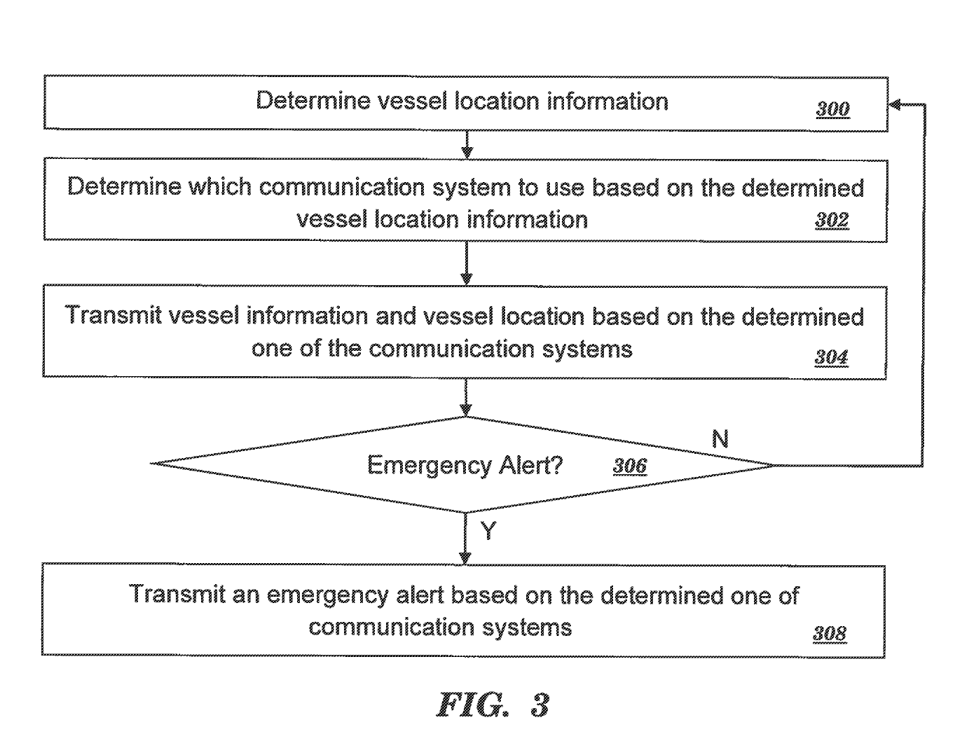

Although an example of the vessel tracking and safety beacon device 14 and the tracking and safety monitoring server 16 are illustrated and described herein with the examples shown in FIGS. 1-3, it is to be understood that these devices are for exemplary purposes only, as many variations of the specific hardware and software used to implement the examples are possible, as will be appreciated by those skilled in the relevant art(s). In addition, two or more computing systems or devices can be substituted for any one of the systems in any embodiment of the examples.

Aspects of this technology may also be embodied as a non-transitory computer readable medium having instructions stored thereon as described and illustrated by way of the examples herein, which when executed by a processor, cause the processor to carry out the steps necessary to implement the methods of the examples, as described and illustrated herein.

Referring now to FIGS. 1-3, an exemplary method of the present technology will now be described. In step 300, when the vessel tracking and safety beacon device 14 is installed, the on/off switch 46 is activated to an on position by the installation when in this example a magnet in a mounting bracket coupled to a housing for the vessel tracking and safety beacon device 14 is detected by the vessel tracking and safety beacon device 14 and one or more of the LEDs 48 may be engaged and/or the audio alarm 42 might provide an audio signal indicating activation. Next, the GPS antenna 34 may receive a GPS signal from a satellite and the GPS module 32 may determine a current location of the vessel for the microcontroller 20.

Additionally, the microcontroller 20 may be configured to continually monitor for any tampering of the case for the vessel tracking and safety beacon device 14 based on a tamper detection signal from the case open detection system 40. If any tampering of the case is detected, then the microcontroller 20 is configured to use one of the communication systems, such as the Iridium 9602 modem and Iridium patch antenna 26, the RPMA communication system, or the 3G module 28 and 3G antenna 30, based on the determined current location to send the tampering signal to the tracking and safety monitoring server 16 or other tampering monitoring system, although other types and/or numbers of factors may be used.

Further, the microcontroller 20 may be configured to interact with any Bluetooth connected device on the vessel via the Bluetooth antenna 38 and Bluetooth radio module 36, although other Bluetooth or other two-way communication systems could be used. By way of example only, the microcontroller 20 may be configured to interact with any Bluetooth connected device on the vessel to provide and/or receive maps, weather information, enforcement and compliance information, and/or emergency information. The Bluetooth antenna 38 and Bluetooth radio module 36 enables any Bluetooth connected device on the vessel to use any of the communication systems for text, email, and/or and other possible messaging between vessel and shore and/or between other vessels to provide information, such as for a rescue. The Bluetooth antenna 38 and Bluetooth radio module 36 enables any Bluetooth connected device on the vessel to obtain other information, such as weather, geo-zone updates, information on nearby mariners in distress, etc. by way of example.

In step 302, the microcontroller 20 may decide in this particular example which one of the communication systems, such as the Iridium 9602 modem and Iridium patch antenna 26, the RPMA communication system, or the 3G module 28 and 3G antenna 30, based on the determined current location, although other types and/or numbers of factors and/or other combinations of two or more communication systems may be used. By way of example, if more than one of the three communication systems may be available based on the determined location and detected connectivity by the microcontroller 20, the microcontroller 20 may use the least expensive option for communications or may use the most reliable communication in an emergency.

In step 304, the microcontroller 20 may transmit the current location of the vessel using the selected one of the communication systems, such as the Iridium 9602 modem and Iridium patch antenna 26, the RPMA communication system, or the 3G module 28 and 3G antenna 30, based on the determined current location to the tracking and safety monitoring server 16, although other types and/or numbers of factors may be used. The current location may be transmitted for example for enforcement and compliance of fishing regulations or policies or for tracking vessels for border security, although the microcontroller 20 maybe configured to send the location information for other purposes.

In step 306, the microcontroller 20 may be configured to determine when the SOS button 44 has been activated for an emergency alert, although the microcontroller 20 may be configured to determine when there is an emergency in other manners. If in step 306, the microcontroller 20 determines that the SOS button 44 has not been activated for an emergency alert, then the No branch is taken back to step 300 as described above. If in step 306, the microcontroller 20 determines that the SOS button 44 has been activated for an emergency alert, then the Yes branch is taken to step 308.

In step 308, the microcontroller 20 may transmit the current location of the vessel using the selected one of the communication systems, such as the Iridium 9602 modem and Iridium patch antenna 26, the RPMA communication system, or the 3G module 28 and 3G antenna 30, based on the determined current location to the tracking and safety monitoring server 16, although other types and/or numbers of factors may be used. The current location may be transmitted for example for emergency reasons as well as any additional information received for example from any Bluetooth connected device on the vessel via the Bluetooth antenna 38 and Bluetooth radio module 36, although the microcontroller 20 maybe configured to send the location information for other purposes.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

1. An autonomous, solar-powered, vessel tracking and safety beacon device comprising:
a global positioning system coupled to at least a solar power system;
one or more communication systems coupled to the solar power system;
a vessel tracking and safety beacon microcontroller system coupled to the global positioning system, the one or more communication systems, and the solar power system, the microcontroller system comprising a memory coupled to a processor which is configured to be capable of executing programmed instructions comprising and stored in the memory to:
provide vessel location information from the global positioning system;
detect when an emergency distress alert has been activated;
determine based on the vessel location information from the global positioning system which of the one or more communication systems to utilize; and
transmit the emergency distress alert using the determined one of the one or more communication systems.

2. The device as set forth as set forth in claim 1 wherein the microcontroller which is further configured to be capable of executing programmed instructions comprising and stored in the memory to:
receive one or more communications in response to the transmitted emergency distress alert.

3. The device as set forth in claim 1 wherein the microcontroller for the determine based on the vessel location information is further configured to be capable of executing programmed instructions comprising and stored in the memory to: determine based on the vessel location information which of a Random Phase Multiple Access (RPMA) communication system and at least one of an Iridium satellite communication system or a global system for mobile (GSM) communication system.

4. The device as set forth in claim 1 further comprising a Bluetooth communication system coupled to the microcontroller system.

5. The device as set forth in claim 4 wherein the Bluetooth communication systems is further configured to enable communications between vessels or to shore via at least one of the two communication systems.

6. The device as set forth as set forth in claim 1 wherein the solar power system further comprises at least one solar power panel.

7. The device as set forth in claim 5 further comprising a rechargeable battery coupled to the vessel tracking and safety beacon microcontroller system, the global positioning system, and the one or more communication systems.

8. The device as set forth as set forth in claim 1 further comprising:
a case which houses the vessel tracking and safety beacon device; and
a case open detection system coupled to the microcontroller system which is further configured to be capable of executing programmed instructions comprising and stored in the memory to:
transmit a tamper notification based on a case open detection signal of an opening the case from the case open detection system.

9. A method for making an autonomous, solar-powered, vessel tracking and safety beacon device, the method comprising:
providing a global positioning system coupled to at least a solar power system;
coupling one or more communication systems to the solar power system;
coupling a vessel tracking and safety beacon microcontroller system to the global positioning system, the one or more communication system, and the solar power system, the microcontroller system comprising a memory coupled to a processor which is configured to be capable of executing programmed instructions comprising and stored in the memory to:
provide vessel location information from the global positioning system;
detect when an emergency distress alert has been activated;
determine based on the vessel location information from the global positioning system which of the one or more communication systems to utilize; and
transmit the emergency distress alert using the determined one of the one or more communication systems.

10. The method as set forth as set forth in claim 9 wherein the microcontroller which is further configured to be capable of executing programmed instructions comprising and stored in the memory to:
receive one or more communications in response to the transmitted emergency distress alert.

11. The method as set forth in claim 9 wherein the microcontroller for the determine based on the vessel location information is further configured to be capable of executing programmed instructions comprising and stored in the memory to: determine based on the vessel location information which of a Random Phase Multiple Access (RPMA) communication system and at least one of an Iridium satellite communication system or a global system for mobile (GSM) communication system.

12. The method as set forth in claim 9 further comprising coupling a Bluetooth communication system to the microcontroller system.

13. The method as set forth in claim 12 wherein the Bluetooth communication systems is further configured to enable communications between vessels or to shore via at least one communication system.

14. The method as set forth as set forth in claim 9 wherein the solar power system further comprises at least one solar power panel.

15. The method as set forth in claim 14 further comprising coupling a rechargeable battery to the vessel tracking and safety beacon microcontroller system, the global positioning system, and the one or more communication systems.

16. The method as set forth as set forth in claim 9 further comprising;
providing a case which houses the vessel tracking and safety beacon device; and
coupling a case open detection system coupled to the microcontroller system which is further configured to be capable of executing programmed instructions comprising and stored in the memory to:
transmit a tamper notification based on a case open detection signal of an opening the case from the case open detection system.
